(19) United States
(12) Patent Application Publication
(10) Pub. No.: US 2004/0044653 A1
(43) Pub. Date: Mar. 4, 2004

(54) Collection shortcut expander

(76) Inventor: Kevin Wade Jameson, Calgary (CA)

Correspondence Address: KEVIN W. JAMESON, 148 EDGE BANK PLACE NW, CALGARY, AB, T3A 4L4, CA

(21) Appl. No.: 10/227,822

(22) Filed: Aug. 27, 2002

(51) Int. Cl. G06F 17/00

(52) U.S. Cl. 707/3

(57) ABSTRACT

A Collection Shortcut Expander method expands shortcut collection reference expressions into complete reference expressions, thereby improving the productivity of people who work with collections. In operation, a Collection Shortcut Expander receives expansion requests from request originators, expands shortcut collection reference expressions into complete collection reference expressions, and returns expanded references to the request originators. Shortcut references to local collections are expanded using information from a current collection specifier file. Shortcut references to remote collections are expanded using information from a knowledge base. Collection Shortcut Expanders improve human productivity by providing convenient syntaxes, by reducing typing burdens, by reducing knowledge burdens, by reducing human retraining costs caused by collection name changes, and by enabling people to create customized alias names for frequently used collection names.

### RELATED APPLICATIONS

Collection Information Manager, USPTO patent application Ser. No. 09/885,078, Kevin W Jameson, Jun. 21, 2001.

Collection Recognizer, USPTO patent application Ser. No. 09/885,080, Kevin W Jameson, Jun. 21, 2001.

Collection Knowledge System, USPTO patent application Ser. No. 09/885,079, Kevin W Jameson, Jun. 21, 2001.

### FIELD OF THE INVENTION

This invention relates to software program methods for expanding shortcut collection references into complete collection reference expressions, thereby improving the productivity of people and computer systems that work with collections of computer files.

### BACKGROUND OF THE INVENTION

The present invention addresses the general problem of low productivity among human knowledge workers who use tedious manual procedures to work with collections of computer files. The most promising strategy for solving this productivity problem is to build automated computer systems to replace manual human effort.

One new software technology for improving productivity-software collections-enables computer programs to process collections of computer files more productively than previously possible. Collections are normal directory structures (“file folders”) of normal computer files, but they contain a special collection specifier file in the root directory of the collection that specifies the data type of the collection. Computer programs that work with collections can use collection data type values as lookup keys into databases to obtain detailed information about known collection data types. The detailed information enables computer programs to better understand the structure and content of the collections that they are processing. Having access to detailed information about collections enables programs to process collections in more intelligent ways than were previously possible.

Collections are useful and practical because they make it easier for computer programs to manipulate the contents of collections that are stored on local file systems accessible to the programs. Typically, users invoke computer programs within a working directory that lies within a collection directory structure. Computer programs recognize the location of the current collection by searching upwards for the special collection specifier file. Once programs know the physical location-the root directory-of the current collection, they can proceed to manipulate the collection to fulfill their processing function.

The method of searching upwards to find a special file in order to identify a collection is called “identity by location,” because collections are located and referenced by their location, not by their name. The software industry has no methods for referencing collections by name, so people have no way of referencing collections independent of their file system location.

The present invention contemplates a collection reference system for solving the problem of referencing collections by name, independent of collection location. But the problem is complex, and has several sub-problems that require solutions. The following paragraphs briefly characterize several of the problems.

The Local Collection Reference Problem is one problem to solve. It is the problem of how to refer to a local collection-or parts of it-when invoking computer programs that work with local and remote collections. A solution requires a practical syntax to distinguish between references to the local copy of a collection and to the original or authoritative remote copy of a collection.

The Local Collection Reference Problem has the following interesting aspects: a practical solution must have a syntax that is short enough to require minimum typing; the syntax must permit references to the whole collection, to one or more subtrees of the collection, to one or more directories of a collection, and to one or more files of a collection.

The Remote Collection Reference Problem is another problem to solve. It is the problem of how to reference a remote collection by name, independent of the collection's actual physical location. A solution requires a practical syntax for referencing sets of collections, individual collections, or parts of collections within large repositories of collections.

The Remote Collection Reference Problem has these interesting aspects: a practical solution must permit references to individual collections, multiple collections within categories of collections, categories of collections, and all collections at a server location.

The Collection Reference Typing Burden Problem is another problem to solve. It is the problem of how to reduce the typing effort required to specify collection references when invoking computer programs to work on collections.

The Collection Reference Typing Burden Problem has these interesting aspects: a solution should allow users to omit parts of the collection reference expression that can be calculated using default values; it should take default values from the local collection instance where appropriate; it should take default values from a program knowledge base where appropriate; and it should calculate default values for empty parts of collection references using user-specified collection reference values, where appropriate.

The Command Operation Typing Burden Problem is another problem to solve. It is the problem of how to reduce the typing effort required to specify default values for command line parameters for program operations that are performed on collections. It is the problem of managing and using command-specific default parameter values for collection operations.

The Command Operation Typing Burden Problem has these interesting aspects: a solution must be application program independent; it must provide for an arbitrary number of possible commands; and it must provide for an arbitrary number of default values for each command.

The Authority Name Knowledge Burden Problem is another problem to solve. It is the problem of reducing human knowledge burdens by automatically calculating default values for authority names that are responsible for managing particular collections. That way users are not responsible for remembering which authority manages which collections. Authority names are typically associated with network servers that store authoritative copies of collections in network-accessible repositories.

The Authority Name Knowledge Burden Problem has these interesting aspects: large numbers of collections and authorities may be involved; authority values may evolve with time; most collection references are for authorities at the local site; and calculation of authority names can be based on collection category names, collection names, or both.

The Collection Reference Alias Problem is another problem to solve. It is the problem of how to use aliases for the various parts of collection references to simplify the use of collection references for humans and programs.

The Collection Reference Alias Problem has these interesting aspects: aliases can be defined for any and all parts of the collection reference syntax; aliases can reduce typing; aliases can support name evolution by redirecting old collection names to new collection names; and aliases can support collection relocations by redirecting old authority names to new authority names.

General Shortcomings Of The Prior Art

The prior art contains no references that are relevant to the subject of the present invention. Even the related patent applications listed at the beginning of this document contain no mention of the problem of referencing collections by name. Accordingly, the following discussion is general in nature, because there are no specific works of prior art to discuss.

Prior art approaches lack support for collections. This is the largest limitation of all because it prevents people and programs from using high-level collection abstractions that can significantly improve productivity.

Prior art approaches lack means for referencing collections by name. This limitation prevents people and programs from referencing collections by name, within a collection namespace that is independent of local file system pathnames. For example, this prior art limitation prevents client programs from referencing collections that are stored on a server, where the client and server do not share file systems.

Prior art approaches lack means for explicitly referencing local collections when programs are invoked within local collection directory structures. Prior art collection recognizers (see the section on related patent applications at the beginning of this document) can implicitly locate a current local collection. But the prior art does not provide means for explicitly referencing the current local collection using command line parameters. This limitation prevents people from distinguishing between references to local and remote collections on command line invocations of computer programs.

Prior art approaches lack means for referencing remote collections by name. This limitation prevents collection names from being usefully passed among programs that do not share file systems. It also prevents people from using convenient collection names to reference collections. Instead, people must currently use “identity by location” techniques-long pathnames-to identify collections to peers and programs.

Prior art approaches lack means for reducing typing burdens on people that work with collections. Full collection identifiers-long pathnames-must be typed each time. No typing shortcuts are possible. No default values can be provided by the system. As a consequence of this limitation, people do more typing than is necessary, and make more typing errors than are necessary.

Prior art approaches lack means for reducing typing burdens caused by frequently used command line parameters for frequently used collection processing programs. This limitation requires people to type the same command line parameters for the same commands over and over again, when default values could relieve the typing burden.

Prior art approaches lack means for reducing knowledge burdens on people who must remember the authority names-typically the Internet domain names-of large numbers of collections that are distributed among many authorities. This limitation means that people must remember the latest authority name for their collections of interest, when default values or dynamic calculations of authority names could relieve the knowledge burden.

Prior art approaches lack means for permitting people to customize collection names and authority names using convenient alias names. This limitation means that people must remember and type in possibly long and tedious names when they could instead use convenient personal short alias names. This limitation also means that people cannot continue to use old names when old names are changed to new names as a result of renames, reorganizations, or other name evolution factors.

As can be seen from the above descriptions, prior art approaches lack the means to make it easy—or even possible—for people to work with local and remote collection names. Prior art approaches lack practical collection referencing syntax, impose heavy typing burdens, impose unnecessary knowledge burdens, and lack the means for customizing collection names using aliases.

In contrast, the present invention has none of these limitations, as the following disclosure will show.

### SUMMARY OF THE INVENTION

A Collection Shortcut Expander method expands shortcut collection reference expressions into complete reference expressions, thereby improving the productivity of people who work with collections. In operation, a Collection Shortcut Expander receives expansion requests from request originators, expands shortcut collection reference expressions into complete collection reference expressions, and returns expanded references to the request originators.

Shortcut references to local collections are expanded using information from a current collection specifier file. Shortcut references to remote collections are expanded using information from a knowledge base.

Collection Shortcut Expanders improve human productivity by providing convenient syntaxes, by reducing typing burdens, by reducing knowledge burdens, by reducing human retraining costs caused by collection name changes, and by enabling people to create customized alias names for frequently used collection names.

### OBJECTS AND ADVANTAGES

The main object of the present invention is to improve the productivity of human knowledge workers by making it possible for them to use convenient shortcut collection names to reference collections.

Another object is to provide syntax for explicitly referencing the local current collection-or interesting parts of it-using convenient collection shortcut names.

Another object is to provide syntax for referencing remote collections-or parts of them-by name, where a collection authority is responsible for managing the remote collections.

Another object is to reduce typing burdens by using default values from local collection specifier files to replace empty fields in shortcut names for local collections.

Another object is to reduce typing burdens by using default values from a database to replace empty fields in shortcut names for remote collections.

Another object is to reduce typing burdens by using operation-specific default command line parameters from a database to augment collection reference expressions for frequently used collection-processing commands.

Another object is to reduce errors by reducing the amount of typing required of users.

Another object is to reduce knowledge burdens by using default authority names or by calculating authority names to replace empty authority fields in collection reference expressions.

Another object is to provide support for alias names in collection reference expressions, thereby improving the convenience of collection reference expressions, and thereby providing a mechanism to redirect old names to new names as the collection names evolve.

As can be seen from the objects above, Collection Shortcut Expanders provide many useful and practical services to people and computer programs that work with collections.

Further advantages of the present Collection Shortcut Expander invention will become apparent from the drawings and disclosure that follow.

### BRIEF DESCRIPTION OF DRAWINGS

The following paragraphs introduce the drawings.

FIG. 1 shows a sample prior art file system folder from a typical personal computer.

FIG. 2 shows how a portion of the prior art folder in FIG. 1 has been converted into a collection 100 by the addition of a collection specifier file 102 named “cspec” FIG. 2 Line 5.

FIG. 3 shows the contents of a collection specifier file 102, implemented with a simple text file from a typical personal computer system.

FIG. 4 shows the structure of a full collection reference.

FIG. 5 shows several example collection references.

FIG. 6 shows a table of example shortcut references and their associated meanings.

FIG. 7 shows an example collection specifier containing two collection views. Each collection view contains multiple collection view member references, which are also known as typed collection references.

FIG. 8 shows the structure of a collection view member reference.

FIG. 9 shows several example collection view member references.

FIG. 10 shows an example name table for collection type names.

FIG. 11 shows an example collection type definition file for C program collections.

FIG. 12 shows an example name table for collection reference type names.

FIG. 13 shows an example collection reference type definition file for collection references that refer to collections.

FIG. 14 shows an example name table for collection view type names.

FIG. 15 shows an example collection view type definition file for collection views of type “view-colls.”

FIG. 16 shows a simplified architecture for an application program 120 that references a local collection 105 in a file system that is accessible from the computer that runs the application program 120.

FIG. 17 shows a simplified, client-server architecture for an application program client 121 that uses a network link to reference a remote, authoritative-copy collection 106 that is managed by an application program server 122

FIG. 18 shows a simplified, client-server architecture for an application program client 121 that references a local collection 105 on a local file system and a remote, authoritative-copy collection 106 on an application program server 122.

FIG. 19 shows a table that summarizes the collection reference requirements of the three architectures shown in FIGS. 16-18.

FIG. 20 shows a simplified architecture for an application program 120 that uses a software module Expand Collection Reference Means 130 to expand shortcut collection reference expressions into complete collection reference expressions.

FIG. 21 shows a simplified algorithm for an Expand Collection Reference Means 130.

FIG. 22 shows a simplified architecture for an Expand Collection Reference Means 130.

FIG. 23 shows an example collection specifier file containing an authoritative home name of a collection Line 3, an example operation-specific control argument Line 6, and an example operation-specific content selector filename Line 7.

FIG. 24 shows an example collection reference defaults policy file for specifying that blank category and collection fields in shortcut collection references should be replaced with wildcard values.

FIG. 25 shows a second example collection reference defaults policy file for specifying that blank fields in shortcut collection references should be replaced with particular values from Column 2.

FIG. 26 shows an example application command operation defaults table that specifies operation-specific default values for scope arguments and content selectors.

FIG. 27 shows an example category-collection alias table that specifies replacement strings for aliases found in the category or collection fields of collection reference expressions.

FIG. 28 shows an example category-authority table that specifies authority names Column 2 for particular category names Column 1 used in collection reference expressions.

FIG. 29 shows an example authority alias table that specifies replacement strings for aliases found in the authority field of collection reference expressions. It also shows how aliases for categories and collections can be stored in the same alias table.

### LIST OF DRAWING REFERENCE NUMBERS

100 A collection formed from a prior art file folder

102 Collection specifier information

105 A local non-authoritative copy of a collection

106 A remote repository of authoritative collections

120 An application program

121 An application program client

122 An application program server

125 A Get Shortcut Collection Reference means

126 A Use Complete Collection Reference means

130 An Expand Collection Reference means

131 A Get Collection Reference Type means

132 A Get Location Status means

133 A Get Local Reference Defaults means

134 A Get Remote Reference Defaults means

135 A Get Command Operation Defaults means

136 A Replace Category-Collection Aliases means

137 A Get Authority Name means

138 A Replace Authority Aliases means

### DETAILED DESCRIPTION

The following disclosure describes the present Collection Shortcut Expander invention with reference to a preferred file system implementation of the invention. However, the invention is not limited to any particular computer operating system, file system, database, or other software implementation. The descriptions that follow should be considered as implementation examples only and not as limitations of the invention.

Introduction to Collections

Collections are sets of computer files that can be manipulated as a set, rather than as individual files. Collection information is comprised of three major parts: (1) a collection specifier that contains information—such as a collection data type—about a collection instance, (2) a collection type definition in a knowledge base that contains information about how to process all collections of a particular type, and (3) optional collection content in the form of arbitrary computer files that belong to a collection.

Collection specifiers contain information about a collection instance. For example, collection specifiers may define such things as the collection type, a text summary description of the collection, collection content members, derivable output products, collection processing information such as process parallelism limits, special collection processing steps, and program option overrides for programs that manipulate collections. Collection specifiers are typically implemented as simple key-value pairs in text files or database tables.

Collection type definitions are user-defined sets of attributes that are stored in a central knowledge base so they can be shared among multiple collections. In practice, collection specifiers contain collection type indicators that reference detailed collection type definitions that are externally stored and shared among all collections of a particular type. Collection type definitions typically define such things as collection types, product types, file types, action types, administrative policy preferences, and other information that is useful to application programs for understanding and processing collections.

Collection content is the set of all files and directories that are members of the collection. By convention, all files and directories recursively located within a collection subtree are collection content members. In addition, collection specifiers can contain collection content directives that add further files to the collection membership. Collection content is also called collection membership.

Collection is a term that refers to the union of a collection specifier and a set of collection content.

Collection information is a term that refers to the union of collection specifier information, collection type definition information, and collection content information.

Collections have many practical applications in the technical arts. They make it convenient for programs and human knowledge workers to manipulate whole sets of computer files where only individual files could be manipulated before. They make it possible to manipulate collections according to standard processing policies that are part of the collection type definition in a database.

Collection Representations

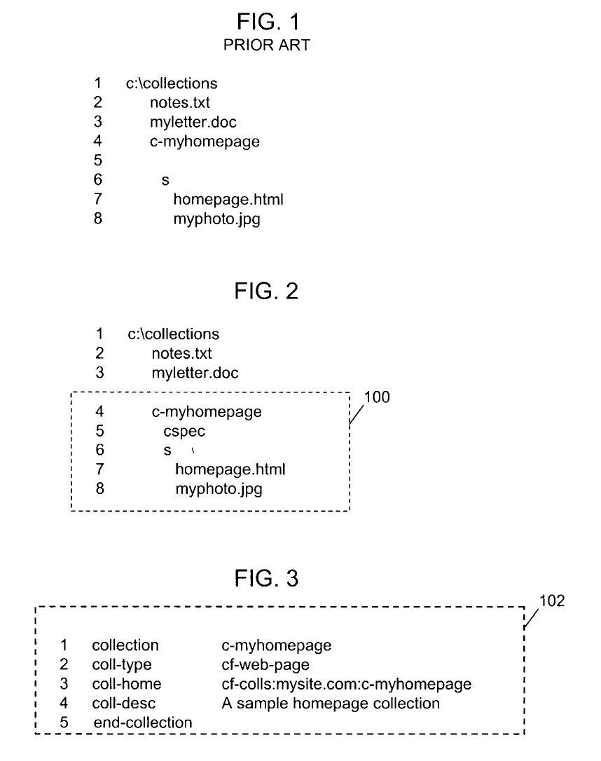

FIGS. 1-3 show a preferred embodiment of collections for a typical personal computer.

FIG. 1 shows a sample prior art file system folder from a typical personal computer.

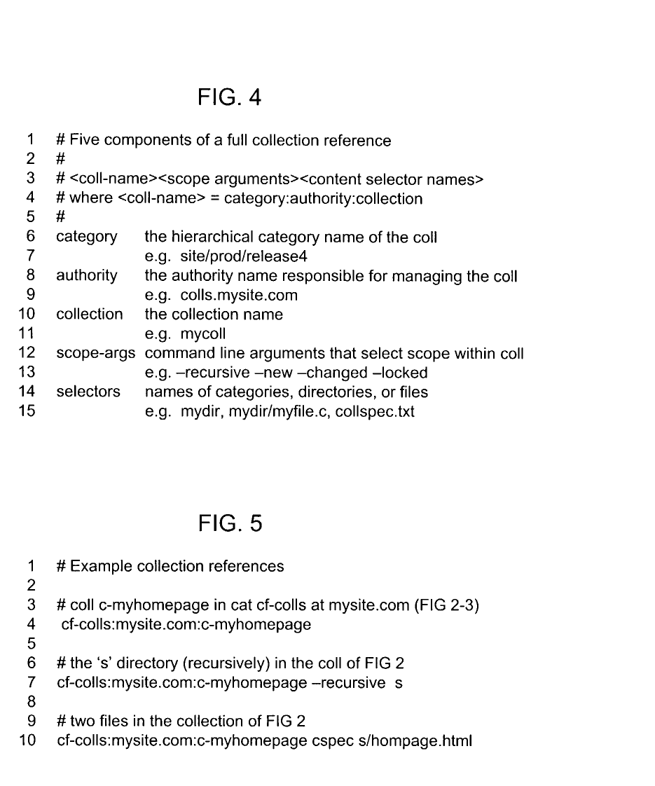

FIG. 2 shows the prior art folder of FIG. 1, but with a portion of the folder converted into a collection 100 by the addition of a collection specifier file FIG. 2 Line 5 named “cspec”. In this example, the collection contents FIG. 2 Lines 4-8 of collection 100 are defined by two implicit policies of a preferred implementation.

First is a policy to specify that the root directory of a collection is a directory that contains a collection specifier file. In this example, the root directory of a collection 100 is a directory named “c-myhomepage” FIG. 2 Line 4, which in turn contains a collection specifier file 102 named “cspec” FIG. 2 Line 5.

Second is a policy to specify that all files and directories in and below the root directory of a collection are part of the collection content. Therefore directory “s” FIG. 2 Line 6, file “homepage.html” FIG. 2 Line 7, and file “myphoto jpg” FIG. 2 Line 8 are part of the collection content for collection 100.

FIG. 3 shows an example collection specifier file 102, FIG. 2 Line 5, for use on a typical personal computer file system.

Introduction to Collection References

Collections are useful and practical software containers for computer files because they make it easier to work with sets of related computer files. Programs can work with collections directly if the programs are invoked within the collection directory structure, but programs cannot reference collections from outside a collection without a proper means for doing so. The restriction of always being forced to work on collections from within their directory structures is a significant limitation in processing flexibility.

Collection references overcome this limitation by making it possible to conveniently refer to collections from outside a collection directory structure. Several different kinds of references are possible, as the following discussion shows. The discussion starts with simple expressions and builds up to collection references.

Expressions are comprised of sequences of characters. Expressions have no meaning until a human or program interprets them with respect to a set of interpretation rules. For example, numeric expressions are comprised of numbers. Alphabetic expressions are comprised of letters. Alphanumeric expressions are comprised of both letters and numbers.

References are comprised of expressions that refer to something when humans or programs interpret the references with respect to a set of interpretation rules. For convenience, humans often name or classify references according to (1) the syntactic form of the reference or to (2) the target of the reference (the referent). Examples of naming references after their syntactic form include numeric references, pointer references, HTTP URL references, and FTP references. Examples of naming references after the referents that are pointed to include document references, file references, and collection references.

Collection References are comprised of expressions that, when interpreted, refer to collections. Collection references can refer to collections in three ways: by name, by location, or by internal properties such as type or content.

References to collections by name only have meaning within collection namespaces that are defined by humans or application programs that manage entries in the namespace. For example, a configuration management system that “understood” collections would specify a particular syntax for referring to collections by name within the managed namespace. One example of a collection name syntax is “<category>: <authority>: <collection>.” The category part is a hierarchical expression that categorizes collections within the collection namespace. The authority part is the name of an authority (usually an Internet hostname such as foo.bar.com) that manages the collection namespace. The collection part is the name of a collection, within the category, within a collection namespace, that is managed by an authority.

References to collections by location are references to file folders or directories in computer file systems. This method works because collections are normally stored in file folders or hierarchical directory structures in computer file systems. The content of a directory structure, namely the presence of a collection specifier, ultimately determines whether the directory actually contains a collection.

References to collections by properties are search expressions that programs use to find and select interesting collections for processing. For example, a searcher might want to refer to all collections of a particular collection type within a collection namespace or within a computer file system.

Shortcut Collection References are short-form references that save people typing effort. The main idea of shortcut references is that people can save typing by omitting various parts of normal collection references. Application programs fill in the missing parts, using default values from the current local working collection, or from default values specified by the application program. Shortcut collection references are very useful in practice because they reduce typing effort and reduce knowledge burdens on human users. People don't have to remember details of long collection references. They can use easy-to-remember shortcut references instead.

Collection Reference Representations

FIGS. 4-6 show several formats for collection references and shortcut references.

FIG. 4 shows the structure of a complete collection reference. FIG. 4 Line 3 shows three main components of a preferred implementation of a complete collection reference—a collection name, a set of scoping arguments, and a set of content selector arguments.

A collection name is comprised of three parts a category name, an authority name, and a collection name. A category name is a hierarchically structured name that groups related collections into categories, just as directory folders group related computer files into directories. An authority name is the name of the authority that is responsible for managing a collection. In practice, an authority name is an Internet Domain Name of a host computer that executes a server program for managing collections. A collection name is the name of a collection.

A collection reference scoping argument modifies a collection reference to refer to particular portions of a whole collection. For example, a “-recursive” scoping argument indicates that a reference should recursively include all directories and filenames below the recursion starting directory. Other examples of scoping arguments include “-new,” “-changed,” “-old,” “-local,” “remote,” and “-locked.” These arguments limit the scope of a collection reference to particular directories and filenames by comparing a local collection copy with a remote authoritative collection copy. Scoping arguments help people to reference just the collection directories and files that interest them.

A collection reference content selector is a particular category, directory, or filename that limits a collection reference to include particular named categories, directories, or filenames. Whereas scoping arguments use properties of collection elements (e.g. new, locked, changed) to limit collection references, content selectors use explicit names of collection content members to limit collection references.

FIG. 5 shows several example collection references that use scoping arguments and content selector arguments. Lines 3-4 show a normal “whole collection” reference for the collection shown in FIG. 2. Lines 6-7 show a collection reference that is limited by scoping and selector arguments to a recursive subtree of the collection that is rooted at the “s” directory shown in FIG. 2 Line 6. Lines 9-10 show a collection reference that is limited by selector arguments to the “cspec” file FIG. 2 Line 5 and to the “s/homepage.html” file FIG. 2 Line 7.

Shortcut Collection References

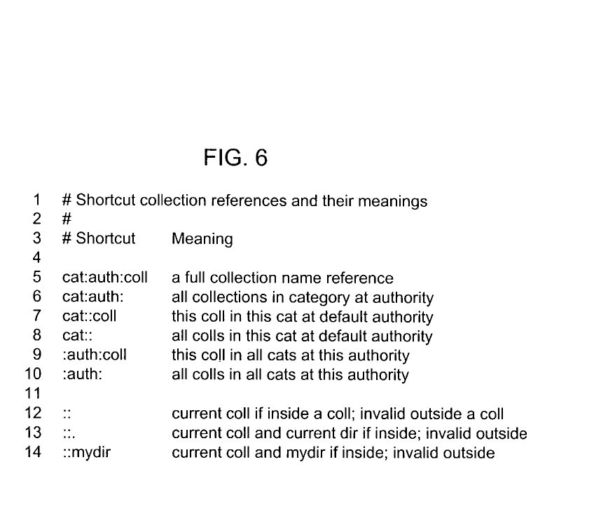

FIG. 6 shows a table of shortcut collection references and their meanings. A shortcut collection reference omits one or more parts of a normal three-part collection name. For example, FIG. 6 Line 6 shows a shortcut reference that omits the third component of a collection name, and thereby refers to “all collections” in the specified category at the specified authority.

Shortcut collection references are very useful in practice. They save typing. They reduce reference errors. They provide increased power and flexibility for referencing individual and multiple categories of collections, authorities, and individual collections. In fact, shortcut collection references have more referential power than complete three-part collection names. This is because complete collection names must provide specific values for a category and a collection, and so cannot refer to all categories, or all collections.

Local and Remote Collection References

FIG. 6 also shows both local and remote collection references. Lines 12-14 show local collection references, and Lines 5-10 show remote collection references.

Local Collection References refer to the current working collection. A current working collection for a program that is making a local collection reference is defined to contain the working directory of the program. Local collection references have no meaning, and are invalid, if no collection contains the working directory of a computer program that is making a local collection reference. In the examples presented in this disclosure, local collection references begin with a double colon “::” as shown in FIG. 6 Lines 12-14. Other syntaxes are also possible.

Remote Collection References do not depend on a program's current working directory being within a collection directory structure. A valid remote collection reference can be made from within any file system directory, whether inside or outside of a collection directory structure. In the examples presented in this disclosure, remote collection references do not start with a double colon “::” character sequence. Other syntaxes are also possible.

FIG. 6 Line 14 shows a reference that could be construed as a remote reference that means “all categories at all authorities that contain a collection called ‘dir’.” This interpretation is legitimate because it is in accordance with the conventions that have been presented above for remote collection references. But that is not the meaning used in this disclosure. Instead, it is more advantageous to use this particular syntax (“::dir”) to refer to local partial collections, for two reasons. First, this syntax is rarely, if ever, used for remote references in practice. Second, the double colon at the beginning of the reference makes it look like a local reference, so it would cause confusion among users if it were used as a remote reference. For these reasons, preferred implementations treat the syntax (“::dir”) as a local collection reference.

Keep in mind that the interpretation of any collection reference is ultimately determined by the implementation policies of the computer program that interprets the reference. This is why other syntaxes are also possible. For example, an application program could specify that local collection references should begin with a double sequence of a non-colon character such as “x.” Then the three shortcut local references shown in FIG. 6 Lines 12-14 would be “xx” “xx<dot>” and “xxdir” (where <dot> means a period). Or a slash could be used, giving “//” “//<dot>” and “//dir.” This disclosure, which explains a preferred implementation, uses double colons for shortcut local collection references, to maintain a consistent look among all collection references. Other implementations are also possible.

Introduction to Collection Views

Collections are useful for representing sets of computer files, and collection references are useful for referring to individual collections. But neither collections nor collection references are useful for referencing sets of collections. This is a significant limitation, because people often want to work with sets of collections, just as they want to work with sets of computer files.

Collection views solve the problem of referencing sets of collections by making it possible for one collection to represent sets of other collections. Collection views enable people and programs to perform operations on whole sets of collections as easily as they can perform operations on single collections.

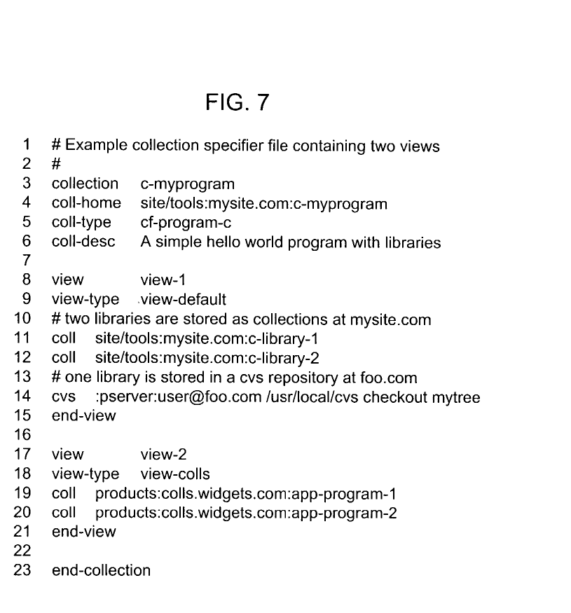

Collection Views are lists of references to other collections. FIG. 7 Lines 17-21 show an example collection view. Collection views are comprised of a view name, a view type, and a list of view member references. A collection view name is a user-defined value that provides a means for referring to the view. A collection view type is a type indicator that associates a view with a particular set of attribute-value pairs that specify useful information about all views of a particular view type. Each unique set of attribute-value pairs is called a collection view type definition. A collection view member reference is a reference that is part of the contents of a collection view.

Collection View Members are physical collections or source trees that are targets of collection view member references contained in collection views. FIG. 2 shows a collection that could be a collection view member. Collection view members are pointed to by collection view member references.

Collection View Member References are references that point to collection view members. FIG. 7 Line 19 shows a collection view member reference. Collection view member references are comprised of collection view member reference types and collection view member reference expressions.

Collection View Member Reference Types are type indicators that associate view member references with particular sets of attribute-value pairs that specify useful information about all view member references of a particular collection view member reference type. Each unique set of attribute-value pairs is called a collection view member reference type definition. FIG. 7 Line 18 Column 2 shows a collection view member type indicator.

Collection View Member Reference Expressions identify particular collections or source trees of computer files that comprise a collection view member. FIG. 7 Line 19 Column 2 shows one example of a collection view member reference expression. FIG. 7 Line 14 Columns 2-N shows a second example of a collection view member reference expression. Application programs use view member reference expressions to access or manipulate view member collections or source trees.

Collection view member reference expressions can take many syntactic forms, corresponding to how the physical collections or source trees are stored. For example, view member reference expressions can be collection reference expressions that name collections, expressions that name modules stored in configuration management systems, URL (Uniform Resource Locator) expressions that point to directories stored on remote servers, or any other kinds of expressions that can be used to identify source trees of computer files that comprise collection view members.

Collection View Representations

FIGS. 7-9 illustrate the structure and format of collection views.

FIG. 7 shows an example collection specifier that contains two collection views. Lines 8-15 show a first view named “view-1” and Lines 17-21 show a second view named “view-2.”

FIG. 7 Lines 17-21 show the structure of a collection view. Line 17 begins the view and specifies the collection view name. Line 18 specifies the collection view type, which associates the view with a set of attribute-value pairs defined in a corresponding collection view type definition. Lines 19-20 specify two collection view member references. Line 21 terminates the collection view.

FIG. 7 Line 19 shows the structure of a collection view member reference. Column 1 specifies a collection view member reference type, which associates a view member reference expression Column 2 with a set of attribute-value pairs defined in a corresponding collection view member reference type definition. Columns 2-N specify a collection view member reference expression and optional arguments.

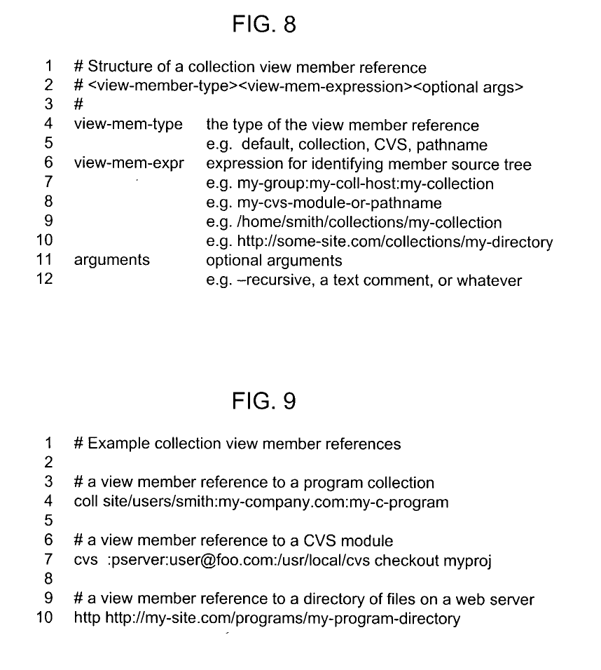

FIG. 8 shows the formal structure of a collection view member reference. Line 2 specifies that a collection view member reference is comprised of three parts-a view member reference type, a view member reference expression, and optional arguments. The functions of these three parts were described in the previous paragraph.

FIG. 9 shows several example collection view member references that contain different view member types and view member reference expression syntaxes.

Introduction to Types and Decorations

Collections, collection references, and collection views are all useful data structures for holding information, but none of them provides information to help programs process the contents of data structures in smart ways.

A better approach to smart processing of these data structures is to provide programs with a separate source of information that contains detailed information about the data structures and the contents therein. That way, programs can read the separate information to easily understand how to process the information content of the three data structures. Types and decorations are a means for providing the separate information.

Types are comprised of a type indicator and a type definition. A type definition contains sets of attribute-value pairs.

Decorations are attribute-value pairs from a type definition. When a collection, collection reference, or collection view is combined with a set of attribute-values pairs from a type definition, we say that it is “decorated.”

Programs usually decorate data structures using the following process. First, programs obtain a collection, collection reference, or collection view data structure to decorate. Second, programs obtain a type indicator for, or from, the data structure. Third, programs use the type indicator to obtain type definition information (decorations) corresponding to the type indicator. Fourth, programs decorate the original data structure by associating it with the attribute-value pairs (decorations) retrieved from the type definition.

Programs determine type indicators in two ways. If a type indicator is part of the original data structure, as is the case for collections and collection views, programs retrieve the type indicator from the data structure. If a type indicator is not part of the original data structure, as is the case with collection references, then programs must calculate a type indicator using other means. Perhaps programs analyze the contents of the data structure to calculate a type, or perhaps they retrieve an external, but associated, type indicator that is not part of the original data structure.

The use of types and decorations gives rise to several new classifications of collection, collection reference, and collection view data structures. Now we can have typed and decorated versions of each data structure. The following paragraphs define each new combination.

Typed Data Structures

Typed Collections are the same as normal collections because normal collections already contain a type indicator as part of the collection data structure. The terms “collection” and “typed collection” are synonymous. FIG. 3 Line 2 Column 2 shows a collection type indicator within a collection specifier file.

Typed Collection References are comprised of an external type indicator and a normal collection reference. FIG. 7 Line 19 shows a typed collection reference. Column 1 specifies a collection reference type and Column 2 specifies a collection reference. Typed collection references are called collection view member references when they appear within collection views.

Typed Collection Views are the same as normal collection views because normal collection views already contain a type indicator as part of the collection view data structure. The terms “collection view” and “typed collection view” are synonymous. FIG. 7 Line 18 Column 2 shows a collection view type indicator within a collection view within a collection specifier.

Decorated Data Structures

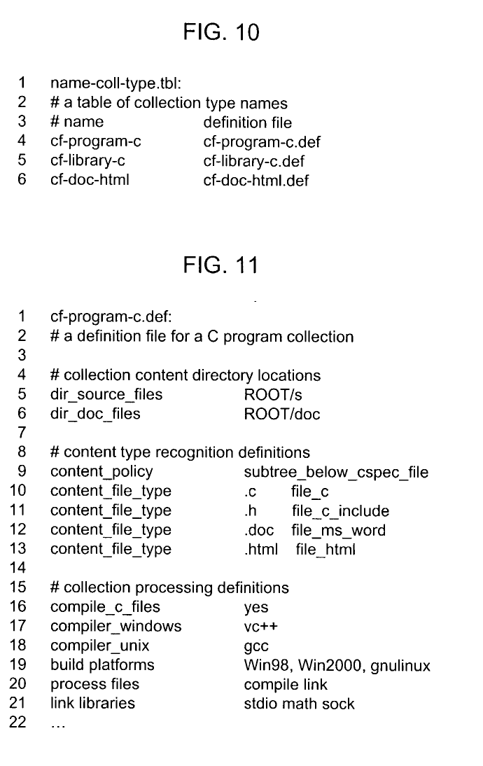

Decorated-Collections are comprised of a collection and decorations in the form of attribute-value pairs from a collection type definition. Decorations specify interesting properties shared by all collections of a particular collection type. Decorated collections are the most useful type of collections to application programs, because they contain decorations that help to tell application programs how to process the decorated collections. FIG. 10 shows an example lookup name table of collection type names. FIG. 11 shows an example collection type definition (decorations). In operation, application programs look up type names in a name table FIG. 10 Column 1 to obtain names of corresponding type definition files FIG. 10 Column 2.

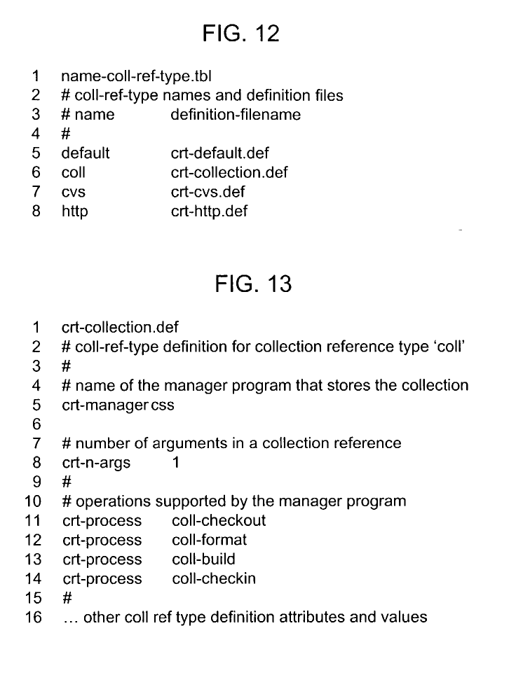

Decorated Collection References are comprised of a collection reference and decorations in the form of attribute-value pairs from a collection reference type definition. Decorations specify interesting properties shared by all collection references of a particular collection reference type. Decorated collection references are the most useful type of collection references for application programs, because the decorations help to tell application programs how to process the decorated collection references. For example, suppose that some attribute-value pairs specified the name of a collection namespace, and how to contact the authority for that namespace. Then an application program could use those attribute-value pairs to contact the authority responsible for the namespace. FIG. 12 shows an example lookup name table of collection view member reference type names. FIG. 13 shows an example collection view member reference type definition (decorations).

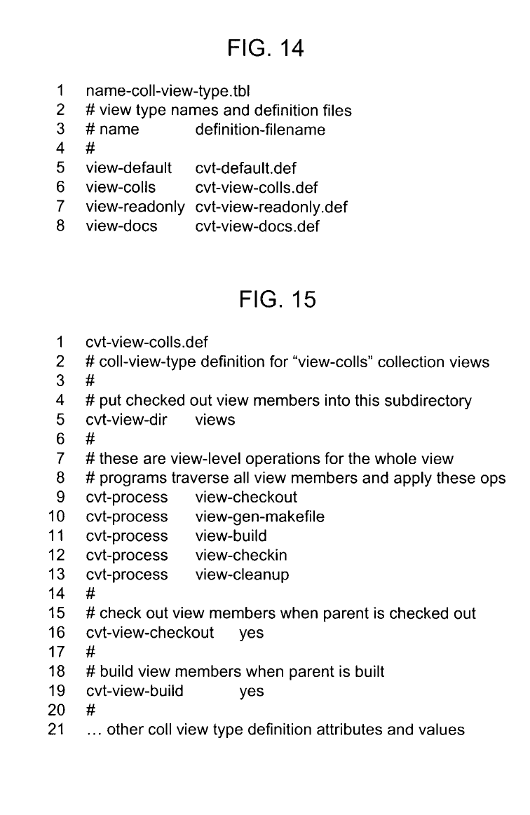

Decorated Collection Views are comprised of (1) a collection view, (2) decorations that specify properties of the collection view, and (3) decorations that specify interesting properties of each of the typed collection references in the view. Decorated collection views are the most useful kind of collection views for application programs because they contain detailed information that help to tell the application programs how to process decorated collection views. FIG. 14 shows an example lookup table of collection view type names. FIG. 15 shows an example collection view type definition (decorations).

Each of the normal, typed, and decorated forms listed above is useful for particular purposes. The normal form of a data structure is efficient for holding the core data content of interest. The typed form of a data structure is most convenient for humans, because it replaces long lists of decorations with a single type indicator token. Finally, the decorated form of a data structure is most convenient for application programs, because it contains additional useful information that helps programs to process the decorated data structures in more useful and more appropriate ways.

Conversion Among Normal, Typed, and Decorated Forms

Since each of the normal, typed, and decorated forms is useful for particular purposes, it is also useful for application programs to convert back and forth among the various representations.

Collection Information Managers are programs that convert typed collections into decorated collections. Recall that typed collections are the same as normal collections because normal collections already contain collection type indicators. Collection information managers produce “collection information” that represents decorated collections.

Collection Information is comprised of a collection specifier, collection type definition information, and collection content information.

Collection Shortcut Expanders are programs that convert shortcut collection references into complete collection references.

Collection View Expanders are programs that convert typed collection views into decorated collection views. Recall that typed collection views are the same as normal collection views because normal collection views already contain collection view types. Collection view expanders produce “collection view information” that represents decorated collection views.

Collection View Information is comprised of a collection view, including a collection view type and a list of collection view member references, and collection view type definition information and a list of corresponding collection view member reference type definition information. Collection view information is nearly equivalent to a list of decorated collection references, with the addition of collection view type definition information.

Collection-Enabled Program Architectures

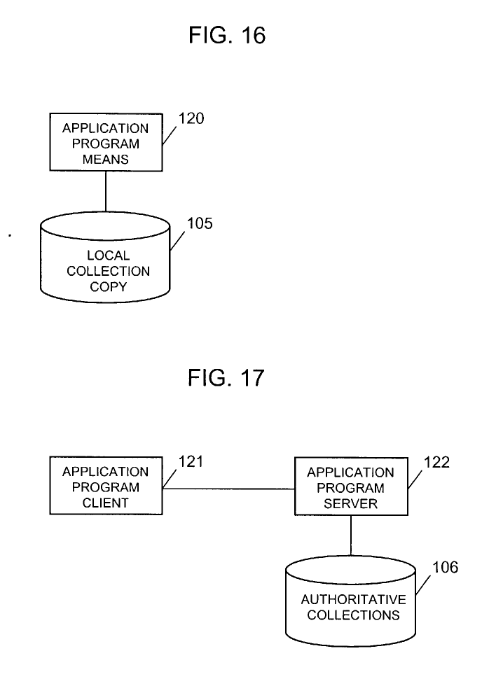

FIGS. 16-18 show example collection-enabled application program architectures. The term “collection-enabled” denotes an ability to work with collections. For example, collection-enabled programs can typically recognize collections, read collection specifier files, obtain collection type information from a database, and process collection contents according to policies defined by collection type definitions.

FIG. 16 shows how a collection-enabled application program 120 could access a local collection 105. In this example, the local collection 105 resides on a local file system that is accessible to the computer that is running the application program. With local access to a collection, an application program 120 can read information directly out of a collection specifier file 102 that belongs to a collection 100.

Typically, a human user invokes an application program 120 in a working directory that lies within a collection directory tree, such as is shown rooted at FIG. 2, Line 4. We say that an application program 120 is “inside” a collection 100 if its current working directory is a descendant of the root directory FIG. 2 Line 4 of the collection 100.

FIG. 17 shows how a collection-enabled application client program 121 could access a remote collection stored in a repository of “official” or “authoritative” collections 106. In this example, the application client program 121 has no local file system access to collections that are managed by the server program 122, so it cannot read information directly out of collection specifier files.

This architecture is characteristic of collection-enabled programs that do not use local copies of collections to accomplish their work. For example, a client program that only gives orders to a server program has no need for local copies of the collection.

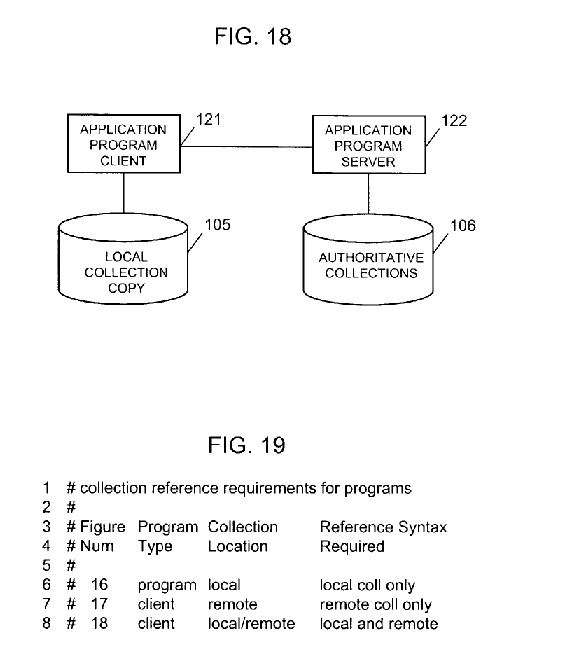

FIG. 18 shows how a collection-enabled application client program 121 could access both a local collection 105 and a remote authoritative version of the same collection 106 with the help of an application program server 122. This architecture is characteristic of collection-enabled programs that work with both local and remote versions of the same collections.

For example, a collection-enabled configuration management system could “check out” one or more local copies of authoritative collections, and “check in” modified versions at a later time. It could also calculate differences between local and remote versions of collections.

Structure Of Collection References

Collection-enabled programs need a way to reference the collections they work on. More specifically, collection-enabled programs need ways to refer to local collections, remote collections, and groups of related remote collections (categories of collections). Collection-enabled programs also need ways of referencing partial collections such as subtrees of collections, or particular directories or files within collections. Ideally, a single syntax should provide all of the required functionality.

FIG. 19 shows a table that summarizes the referencing requirements of the three program architectures presented above. The local program shown in FIG. 16 needs to reference only local collections. The client program shown in FIG. 17 needs to reference only remote collections. But the client program shown in FIG. 18 needs to reference both local and remote collections.

Expansion of Shortcut References

The two main goals of the present invention are to provide means for people to reference both local and remote collections using convenient shortcut references, and to provide means for expanding shortcut references into complete references. Two sources of information are used by the present invention to obtain default values for expanding shortcut collection references.

Local default information resides in the collection specifier file in the current collection. In particular, the present invention frequently uses the authoritative name of the local collection FIG. 3 Line 3 as a source of default values for shortcut collection name references.

Remote default information resides in a local database of predefined default values, rather than in a local collection specifier file. The present invention uses remote default information to expand both local and remote collection references. Remote default information is normally used to provide default authority names and operation-specific default scoping and selector values.

Having described the structure, type, shortcut, local, remote, and expansion forms of collection references, we now describe a preferred embodiment of the present Collection Shortcut Expander invention.

Application Program Expansion Example

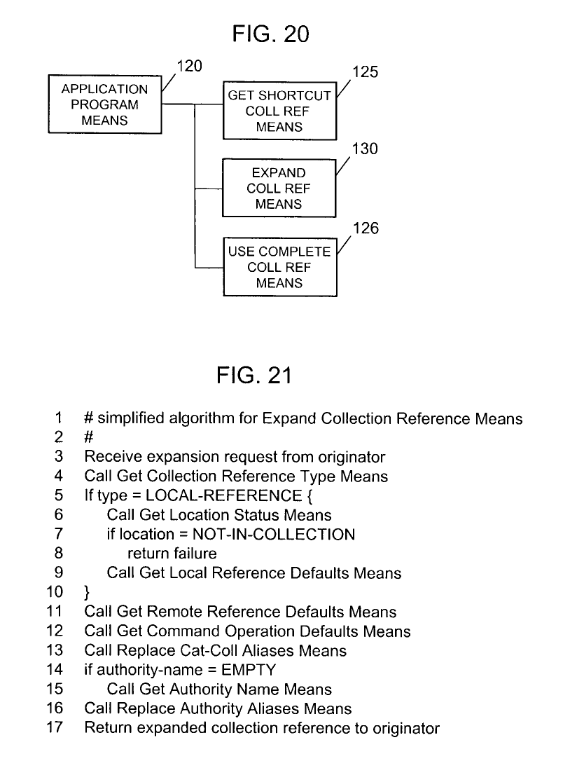

FIG. 20 shows a simplified architecture for an application program that uses an Expand Collection Reference Means 130 to expand shortcut collection references.

Module Application Program 120 is a collection-enabled application program that works with collections and that uses collection references.

Module Get Shortcut Collection Reference Means 125 obtains a collection reference using normal software means known to the art. For example, the module might get a shortcut collection reference from a command line invocation, or by reading the collection reference from a file or network connection, or by calculating the shortcut reference from other data values.

Module Expand Collection Reference Means 130 expands incoming shortcut collection references into complete collection references by replacing blank field values with default values and by replacing aliased field values with alias replacement values.

Module Use Complete Collection Reference Means 126 uses the complete collection reference for the processing purposes of Application Program 120. For example, the application program might perform an operation on the collection that is named by the complete collection reference, or it might pass the complete collection reference to a server program for use on the server computer.

In operation, an Application Program 120 obtains a shortcut collection reference using a Get Shortcut Collection Reference Means 125. Next, application program 120 calls module Expand Collection Reference Means 130 to expand the current reference into a complete collection reference. Finally, application program 120 calls module Use Complete Collection Reference Means 126 to use the expanded collection reference.

Module Expand Collection Reference Means

FIG. 21 shows a simplified algorithm for a module Expand Collection Reference Means 130.

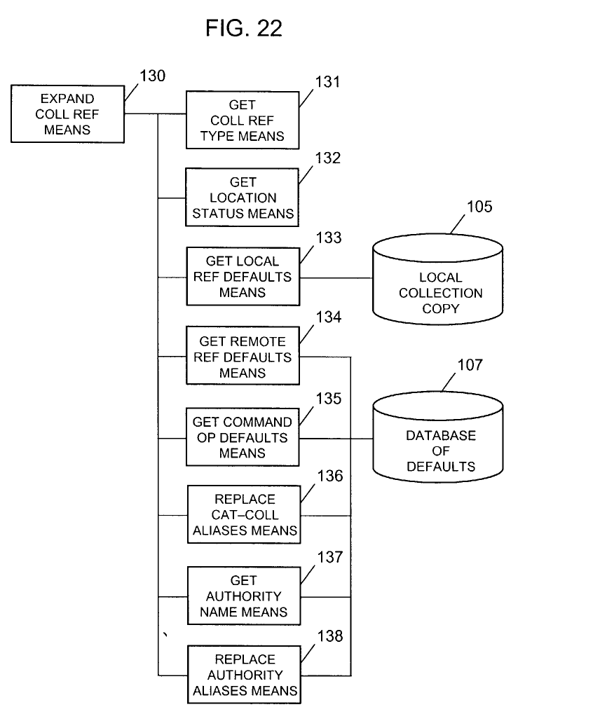

FIG. 22 shows a simplified architecture for module Expand Collection Reference Means 130. Several subordinate modules 131-138 help to carry out the function of module Expand Collection Reference Means 130.

Module Get Collection Reference Type Means 131 inspects a shortcut collection reference and determines if the reference is a local reference (e.g. begins with a double-colon) or a remote reference.

Module Get Location Status Means 132 determines if the current working directory of the invoking program is within the bounds of a collection subtree whose root directory contains a collection specifier file (that is, if the program is “inside” a collection).

Module Get Local Reference Defaults Means 133 obtains default reference expansion values from a local collection specifier file. FIG. 22 depicts such a local collection specifier file as a database Local Collection Copy 105.

Module Get Remote Reference Defaults Means 134 obtains default reference expansion values from a database of default values. FIG. 22 depicts such a database as a Database Of Defaults 107.

Module Get Command Operation Defaults Means 135 obtains operation-specific scope and selector default values from a database of default values 107.

Module Replace Category-Collection Aliases Means 136 replaces category and collection alias names in collection references with replacement values from a database of default values 107.

Module Get Authority Name Means 137 determines an authority name for collection references that do not already contain an authority name, using a database of default values 107.

Module Replace Authority Aliases Means 138 replaces authority alias names in collection references with replacement values from a database of default values 107.

In operation, Module Expand Collection Reference Means 130 proceeds according to the simplified algorithm shown in FIG. 21. First it determines if the incoming reference is a local or remote reference.

If the incoming shortcut reference is a local collection reference, then Module Expand Collection Reference Means 130 calls Modules 132-133 to obtain and apply defaults from the local collection specifier file. Algorithm steps FIG. 21 Lines 5-10 convert the original shortcut reference into a partially complete remote reference, because the reference no longer begins with a double colon character sequence.

The algorithm continues by sequentially calling Modules 134-136 to obtain and apply remote reference defaults and operation-specific defaults, and to replace category and collection alias names using string replacements from the database of defaults 107. At this time, the collection reference may or may not contain an authority name.

If the authority name field is empty, an authority name is determined by module Get Authority Name Means 137 using values from the database of default values 107.

Finally, authority alias names are replaced by module Replace Authority Name Aliases Means 138, and the complete collection reference is returned by Expand Collection Reference Means 130 to its caller module.

Module Get Collection Reference Type Means

Module Get Collection Reference Type Means 131 inspects the shortcut collection reference and determines if the reference is a local reference (e.g. begins with a double-colon) or a remote reference.

In operation, the determination is performed with a simple string comparison between the implementation-defined local short character sequence (e.g. “::” double-colon) and the first few characters of the shortcut collection reference.

Module Get Location Status Means

Module Get Location Status Means 132 determines if the current working directory of the invoking program is within the bounds of the collection subtree whose root directory contains a collection specifier file.

In operation, the determination of location status is preferentially performed with the help of a Collection Recognizer Means. Collection Recognizers usually determine location status by searching upward from the current working directory for a collection specifier file. If a collection specifier file is found above the working directory, then the invoking program is considered to be “inside” a collection. For more information on Collection Recognizers, see the section on related patent applications at the beginning of this document.

Module Get Local Defaults Means

Module Get Local Reference Defaults Means 133 obtains default reference expansion values from a local collection specifier file. FIG. 22 depicts such a local collection specifier file as a database Local Collection Copy 105.

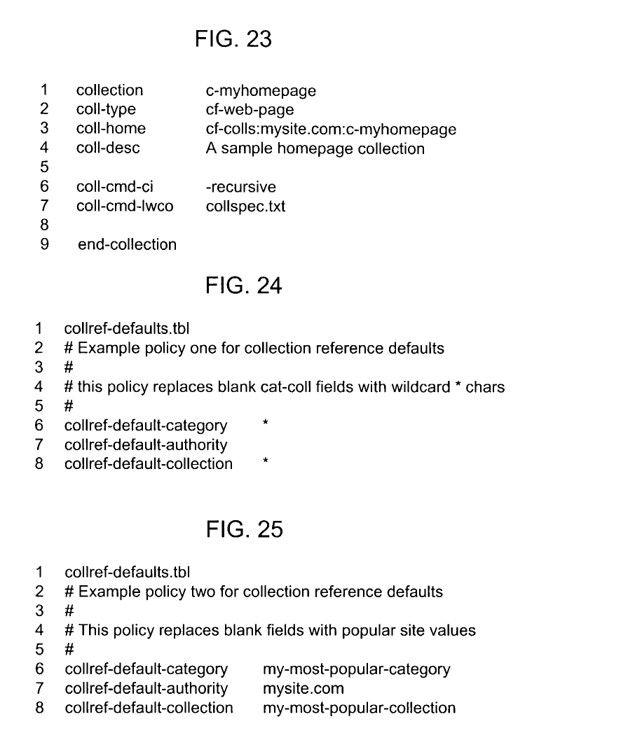

In operation, Module Get Local Reference Defaults Means 133 typically obtains default values by reading a collection specifier text file such as shown in FIG. 3 or FIG. 23. However, other methods may be used if collection specifiers are not represented as text files. For more information on other ways of representing collections, see the section on related patent applications at the beginning of this document.

Module Get Remote Reference Defaults Means

Module Get Remote Reference Defaults Means 134 obtains default reference expansion values from a database of default values 107. FIG. 24 and FIG. 25 show two possible policy implementations for how to replace blank fields in shortcut collection references.

FIG. 24 Lines 6 and 8 specify that blank category and collection fields should be replaced with wildeard asterisk characters. A wildcard asterisk character in a name field means “all names” (in this example, “all categories” and “all collections” respectively). FIG. 24 Line 7 specifies that blank authority names be left alone, so that a default authority name can be calculated by module Get Authority Name Means 137. This set of default values is the preferred embodiment for sites that work with many categories and collections because it provides the most intuitive and flexible shortcut reference expressions.

FIG. 25 Lines 6-8 specify that particular category, authority, and collection names be used to replace blank fields in shortcut collection references. Under this implementation policy, people who want to reference “all categories” or “all collections” must explicitly use implementation-defined wildcard characters instead of using blank fields. This set of default values is appropriate for sites that work almost exclusively with one particular collection in one particular category at one particular authority (which would be exceedingly rare in practice).

In operation, module Get Remote Reference Defaults Means 134 proceeds by replacing blank fields in shortcut reference expressions with default values obtained from the database of defaults 107 (which may be implemented using text files such as FIG. 24 and FIG. 25).

Module Get Command Defaults Means

Module Get Command Operation Defaults Means 135 obtains operation-specific scope and selector default values from a database of default values 107.

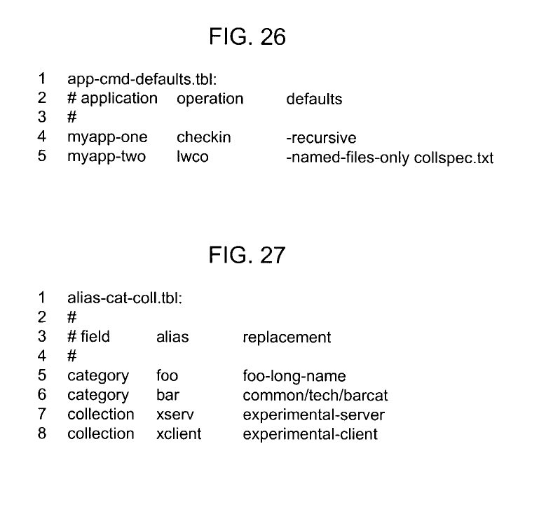

FIG. 26 shows an example table of operation-specific default scoping and selector values. Column 1 contains application program names. Column 2 contains application operation names. Column 3 contains scoping and selector arguments.

In operation, module Get Command Operation Defaults Means 135 proceeds by obtaining an application program and operation name from the original collection reference expansion request. It uses the application program name and operation names as lookup keys into columns 1 and 2 of a table of default values FIG. 26. If a match is obtained in columns 1 and 2, the scope and selector arguments from column 3 are added to the partial collection reference.

Operation-specific default values are useful because they make it possible to save typing and to reduce errors at the granularity level of individual command operations. They also allow people to customize the default behavior of particular command operations.

Module Replace Category-Collection Aliases Means

Module Replace Category-Collection Aliases Means 136 replaces category and collection alias names in collection references with replacement values from a local database of default values.

FIG. 27 shows an example table of alias names and replacements. Column 1 contains the type of the alias entry. This example table uses a type value in column 1 to show how aliases for both categories and collections can be stored in a single table. Other table structures are possible, as determined by implementation policy. Column 2 contains alias names to replace. Column 3 contains replacement names.

In operation, module Replace Category-Collection Aliases Means 136 proceeds by replacing aliases in the incoming collection reference expression with replacement names from the table. If matches are obtained in columns 1 and 2, replacements are done using values from column 3. Otherwise, non-alias field values are left alone.

Module Get Authority Name Means

Module Get Authority Name Means 137 determines an authority name for collection references that do not already contain an authority name, using a database of default values 107.

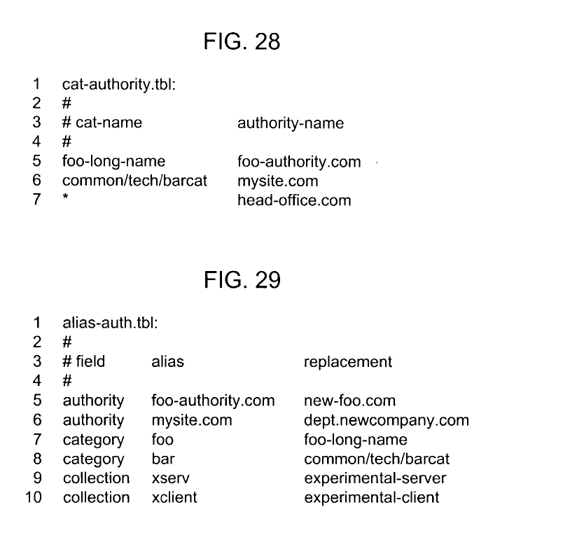

FIG. 28 shows an example of category-authority name pairs that can be used to determine an authority name from a category name. Column 1 contains a collection category name. Column 2 contains an associated authority name.

The purpose of this table is to free people from having to remember which authority is responsible for collections in a particular category. People can simply use shortcut references of the form “category::collection” without worrying about entering a correct authority name.

In operation, module Get Authority Name Means 137 uses the category name from the incoming shortcut reference as a lookup key into the example table in FIG. 28. If a match is found between the incoming category name and a value in Column 1, then the corresponding authority name from Column 2 is inserted into the blank authority field of the shortcut reference.

Note the use of a wildcard category match asterisk in FIG. 28 Line 7. This match rule specifies that if no other category name matches, then a match will be forced by Line 7, and blank authority name fields will be replaced with the Line 7 Column 2 default authority name value.

Module Replace Authority Aliases Means

Module Replace Authority Aliases Means 138 replaces authority alias names in collection references with replacement values from a local database of default values 107.

FIG. 29 shows an example table of alias names and replacements. Column 1 contains the type of the alias entry. This example table uses a type value in column 1 to show how aliases for categories, authorities, and collections can be stored in a single table. Column 2 contains alias names to replace. Column 3 contains replacement names.

In operation, module Replace Authority Aliases Means 136 proceeds by replacing aliases in the authority name field of the incoming collection reference expression with replacement names from the table. If matches are obtained, replacements are done. Otherwise, non-alias field values are left alone.

### CONCLUSION

The present Collection Shortcut Expander invention has a practical application in the technological arts. It enables people to reference collections using convenient shortcut expressions, saves people typing effort, and reduces collection reference errors.

It provides practical solutions to six important problems faced by people who work with collections. The six problems are: (1) the Local Collection Reference Problem, (2) the Remote Collection Reference Problem, (3) the Collection Reference Typing Burden Problem, (4) the Command Operation Typing Burden Problem, (5) the Authority Name Knowledge Burden Problem, and (6) the Collection Reference Alias Problem.

In particular, the present invention makes it possible for people and computer programs to reference collections of computer files using a scalable and convenient syntax that was not previously known to the art.

Ramifications

Although the foregoing descriptions are specific, they should be considered as example embodiments of the invention, and not as limitations of the invention. Many other possible ramifications can be imagined within the teachings of the disclosures made here.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be spread across a different set of coherent data structures, or could be split into a plurality of smaller data structures for implementation convenience, without loss of purpose or functionality.

As a second example, particular software architectures have been presented here to strongly associate primary algorithmic functions with primary modules in the software architectures. However, because software is so flexible, many different associations of algorithmic functionality and module architectures are also possible, without loss of purpose or technical capability. At the under-modularized extreme, all algorithmic functionality could be contained in one big software module. At the over-modularized extreme, each tiny algorithmic function could be contained in a separate little software module. Program modules could be contained in one executable, or could be implemented in a distributed fashion using client-server architectures and N-tier application architectures, perhaps involving application servers and serviets of various kinds.

As a third example, particular simplified algorithms have been presented here to generally describe the primary algorithmic functions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented in this disclosure comprise one such implementation, which was chosen to emphasize conceptual clarity.

From the above, it can be seen that there are many possible equivalent implementations of almost any software architecture or algorithm. Thus when considering algorithmic and functional equivalence, the essential inputs, outputs, associations, and applications of information that truly characterize an algorithm should be considered. These characteristics are much more fundamental to software inventions than are flexible architectures, simplified algorithms, or particular organizations of data structures.

Means For Retrieving Information

The foregoing disclosure used simple text files to illustrate structured tables of information, but other implementations are also possible. For example, all software means for retrieving information from the simple text files shown in the disclosure might retrieve information from a relational database, or from a Collection Knowledge System. For more information on Collection Knowledge Systems, see the section on related patent applications at the beginning of this document.

Local Collection Reference Syntax

The foregoing disclosure uses a double colon (“::”) character sequence to indicate the beginning of a local collection reference expression. However, other implementations are also possible. For example, local collection references could begin with a capital L character, like the following three examples show: “L” “L.”, and “Ldir”. In general, any useful and practical syntax can be used by an implementation to distinguish local collection references from remote collection references.

Get Local Reference Defaults Means

The foregoing disclosure described a Get Local Reference Defaults Means 133 for retrieving information from a collection specifier file within a local collection. However, other sources of local default information are also possible.

For example, people could explicitly designate a collection name of interest to be used as a source of default collection name information. In that case, a Get Local Reference Default Means 133 would not have to read a collection specifier file. Further, an Expand Collection Reference Means 130 would not have to use a Get Location Status Means 132 to determine if the current working directory was inside a collection subtree.

The foregoing disclosure used a collection reference structure comprised of three parts (collection name, scoping arguments, selector arguments) and a collection name structure comprised of three parts (category, authority, collection). But a Get Local Reference Defaults Means 133 is not required to retrieve default values for all collection reference parts or all collection name parts.

Instead it can retrieve any or all default values that are appropriate for the collection reference and collection name structures that are being used by the implementation. For example, if two-part or four-part local collection reference structures or collection name structures were used by the implementation, a Get Local Reference Defaults Means 133 could retrieve a corresponding number of default values.

Get Remote Reference Defaults Means

The foregoing disclosure used a collection reference structure comprised of three parts (collection name, scoping arguments, selector arguments). It also used a collection name structure comprised of three parts (category, authority, collection).

But a Get Remote Reference Defaults Means 134 is not required to retrieve default values for all collection reference parts or all collection name parts. Instead it can retrieve any or all default values that are appropriate for the collection reference and collection name structures that are being used by the implementation.

For example, if two-part or four-part remote collection reference structures or collection name structures were used by the implementation, a Get Remote Reference Defaults Means 134 could retrieve a corresponding number of default values.

Get Authority Name Means

The foregoing disclosure illustrated a Get Authority Name Means 137 with an implementation that used a simple text file table to associate collection category names (column 1) with authority names (column 2). However, other practical and useful implementations are also possible.

For example, authority names could be determined from the current collection name, from the previous authority name used, or from the third part of the current collection name.

In cases where multiple authorities manage copies of collections, an authority name might be determined from a round-robin selection from a list of authority names to spread bandwidth or computational load among servers. Or the first authority to respond to a query might be used because it is the nearest, the fastest, or the most lightly loaded authority available.

An authority name might be chosen according to the current command operation that is being performed. Read-only operations might be directed to one authority, and write-only operations might be directed to another authority, which might be considered the master authority.

Alternative Implementations

The foregoing disclosure used a simple architecture to illustrate how an Expand Collection Reference Means 130 could be used by an Application Program 120 to expand shortcut collection references. But other implementations are possible. An Expand Collection Reference Means 130 server program could provide its services to many application programs on a network. This would reduce the risk of having different expansion policies and behaviors among programs at a site.

Practical Applications

The present Collection Shortcut Expander invention has many practical applications in the technical arts. For example, configuration management systems and automated software build systems could use a Collection Shortcut Expander to make it easier for people to reference collections while performing application operations. In general, any computer program that manipulates collections could benefit from the present invention.

Scope

The full scope of the present invention should be determined by the accompanying claims and their legal equivalents, rather than from the examples given in the specification.

I claim:

1. A Collection Shortcut Expander process for delivering expanded collection references to programs, to be performed on or with the aid of a computer, comprising the following steps:
(a) receiving an expansion request to expand a collection reference,
(b) performing an expansion action using information from said expansion request, and
(c) returning results from said expansion action to the request originator,
wherein a collection reference is comprised of a collection name, a set of scoping arguments, and a set of content selector arguments, and wherein a collection name is comprised of a category name, an authority name, and a collection name, and
wherein collections are data structures comprised of a collection specifier and collection content containing zero or more collection content files, and wherein a collection specifier contains information about a collection instance, and wherein collection content is the set of all files and directories that are members of a collection,
thereby solving the Local Collection Reference Problem, solving the Remote Collection Reference Problem, and improving the productivity of people who work with collections.

2. The process of claim 1, wherein
(a) said step of performing an expansion action uses a Get Collection Reference Type Means to determine if local reference default information should be used to perform said expansion action,
thereby improving human productivity by enabling programs to use local collection reference default information as a source for default values in collection references.

3. The process of claim 1, wherein
(a) said step of performing an expansion action uses a Get Location Status Means to determine if the current working directory is within a collection directory subtree,
thereby improving human productivity by automatically determining if local collection specifier values are accessible for use by said expansion action.

4. The process of claim 1, wherein
(a) said step of performing an expansion action uses a Get Local Reference Defaults Means to obtain default values for use in said expansion action,
thereby helping to solve the Collection Reference Typing Burden Problem and improving human productivity by reducing typing effort and the potential for command line errors.

5. The process of claim 1, wherein
(a) said step of performing an expansion action uses a Get Remote Reference Defaults Means to obtain default values for use in said expansion action,
thereby helping to solve the Collection Reference Typing Burden Problem and improving human productivity by reducing typing effort and the potential for command line errors.

6. The process of claim 1, wherein
(a) said step of performing an expansion action uses a Get Command Operation Defaults Means to obtain default command line parameter values for use in said expansion action,
thereby solving the Command Operation Typing Burden Problem and improving human productivity by freeing human users from typing the same command line parameters over and over again for frequently used collection-processing operations.

7. The process of claim 1, wherein
(a) said step of performing an expansion action uses a Replace Category-Collection Aliases Means to replace collection reference aliases with desired replacement values,
thereby helping to solve the Collection Reference Alias Problem and improving human convenience by supporting the use of customized aliases for collection names.

8. The process of claim 1, wherein
(a) said step of performing an expansion action uses a Get Authority Name Means to obtain a collection reference authority name for use in said expansion action,
thereby solving the Authority Name Knowledge Burden Problem and improving human convenience by freeing human users from having to remember and type particular authority names when working with large numbers of particular individual collections.

9. The process of claim 1, wherein
(a) said step of performing an expansion action uses a Replace Authority Aliases Means to replace collection reference authority aliases with desired replacement values,
thereby helping to solve the Collection Reference Alias Problem and improving human productivity by reducing typing, reducing errors, and by enabling redirection of old names to new names as old names are changed over time.

10. A programmable Collection Shortcut Expander device for delivering expanded collection references to programs, whose actions are directed by software executing a process comprising the following steps:
(a) receiving an expansion request to expand a collection reference,
(b) performing an expansion action using information from said expansion request, and
(c) returning results from said expansion action to the request originator,
wherein a collection reference is comprised of a collection name, a set of scoping arguments, and a set of content selector arguments, and wherein a collection name is comprised of a category name, an authority name, and a collection name, and
wherein collections are data structures comprised of a collection specifier and collection content containing zero or more collection content files, and wherein a collection specifier contains information about a collection instance, and wherein collection content is the set of all files and directories that are members of a collection,
thereby solving the Local Collection Reference Problem, solving the Remote Collection Reference Problem, and improving the productivity of people who work with collections.

11. The programmable device of claim 10, wherein
(a) said step of performing an expansion action uses a Get Collection Reference Type Means to determine if local reference default information should be used to perform said expansion action,
thereby improving human productivity by enabling programs to use local collection reference default information as a source for default values in collection references.

12. The programmable device of claim 10, wherein
(a) said step of performing an expansion action uses a Get Location Status Means to determine if the current working directory is within a collection directory subtree,
thereby improving human productivity by automatically determining if local collection specifier values are accessible for use by said expansion action.

13. The programmable device of claim 10, wherein
(a) said step of performing an expansion action uses a Get Local Reference Defaults Means to obtain default values for use in said expansion action,
thereby helping to solve the Collection Reference Typing Burden Problem and improving human productivity by reducing typing effort and the potential for command line errors.

14. The programmable device of claim 10, wherein
(a) said step of performing an expansion action uses a Get Remote Reference Defaults Means to obtain default values for use in said expansion action,
thereby helping to solve the Collection Reference Typing Burden Problem and improving human productivity by reducing typing effort and the potential for command line errors.

15. The programmable device of claim 10, wherein
(a) said step of performing an expansion action uses a Get Command Operation Defaults Means to obtain default command line parameter values for use in said expansion action,
thereby solving the Command Operation Typing Burden Problem and improving human productivity by freeing human users from typing the same command line parameters over and over again for frequently used collection-processing operations.

16. The programmable device of claim 10, wherein
(a) said step of performing an expansion action uses an Expand Category-Collection Aliases Means to replace collection reference aliases with desired replacement values,
thereby helping to solve the Collection Reference Alias Problem and improving human convenience by supporting the use of customized aliases for collection names.

17. The programmable device of claim 10, wherein
(a) said step of performing an expansion action uses a Get Authority Name Means to obtain a collection reference authority name for use in said expansion action,
thereby solving the Authority Name Knowledge Burden Problem and improving human convenience by freeing human users from having to remember and type particular authority names when working with large numbers of particular individual collections.

18. The programmable device of claim 10, wherein
(a) said step of performing an expansion action uses an Expand Authority Aliases Means to replace collection reference authority aliases with desired replacement values,
thereby helping to solve the Collection Reference Alias Problem and improving human productivity by reducing typing, reducing errors, and by enabling redirection of old names to new names as old names are changed over time.

19. A computer readable memory, encoded with data representing a Collection Shortcut Expander computer program, that can be used to direct a computer when used by the computer, comprising:
(a) means for receiving an expansion request to expand a collection reference,
(b) means for performing an expansion action using information from said expansion request, and
(c) means for returning results from said expansion action to the request originator,
wherein a collection reference is comprised of a collection name, a set of scoping arguments, and a set of content selector arguments, and wherein a collection name is comprised of a category name, an authority name, and a collection name, and
wherein collections are data structures comprised of a collection specifier and collection content containing zero or more collection content files, and wherein a collection specifier contains information about a collection instance, and wherein collection content is the set of all files and directories that are members of a collection,
thereby solving the Local Collection Reference Problem, solving the Remote Collection Reference Problem, and improving the productivity of people who work with collections.

20. The computer readable memory of claim 19, wherein
(a) said means for performing an expansion action uses a Get Collection Reference Type Means to determine if local reference default information should be used to perform said expansion action,
thereby improving human productivity by enabling programs to use local collection reference default information as a source for default values in collection references.

21. The computer readable memory of claim 19, wherein
(a) said means for performing an expansion action uses a Get Location Status Means to determine if the current working directory is within a collection directory subtree,
thereby improving human productivity by automatically determining if local collection specifier values are accessible for use by said expansion action.

22. The computer readable memory of claim 19, wherein
(a) said means for performing an expansion action uses a Get Local Reference Defaults Means to obtain default values for use in said expansion action,
thereby helping to solve the Collection Reference Typing Burden Problem and improving human productivity by reducing typing effort and the potential for command line errors.

23. The computer readable memory of claim 19, wherein
(a) said means for performing an expansion action uses a Get Remote Reference Defaults Means to obtain default values for use in said expansion action,
thereby helping to solve the Collection Reference Typing Burden Problem and improving human productivity by reducing typing effort and the potential for command line errors.

24. The computer readable memory of claim 19, wherein
(a) said means for performing an expansion action uses a Get Command Operation Defaults Means to obtain default command line parameter values for use in said expansion action,
thereby solving the Command Operation Typing Burden Problem and improving human productivity by freeing human users from typing the same command line parameters over and over again for frequently used collection-processing operations.

25. The computer readable memory of claim 19, wherein
(a) said means for performing an expansion action uses a Replace Category-Collection Aliases Means to replace collection reference aliases with desired replacement values,
thereby helping to solve the Collection Reference Alias Problem and improving human convenience by supporting the use of customized aliases for collection names.

26. The computer readable memory of claim 19, wherein
(a) said means for performing an expansion action uses a Get Authority Name Means to obtain a collection reference authority name for use in said expansion action,
thereby solving the Authority Name Knowledge Burden Problem and improving human convenience by freeing human users from having to remember and type particular authority names when working with large numbers of particular individual collections.

27. The computer readable memory of claim 19, wherein
(a) said means for performing an expansion action uses a Replace Authority Aliases Means to replace collection reference authority aliases with desired replacement values,
thereby helping to solve the Collection Reference Alias Problem and improving human productivity by reducing typing, reducing errors, and by enabling redirection of old names to new names as old names are changed over time.
